(19) United States
(12) Patent Application Publication
(10) Pub. No.: US 2020/0129997 A1
(43) Pub. Date: Apr. 30, 2020

(54) OLFACTORY SIMULATION SYSTEM FOR HEAD-MOUNTED DISPLAYS

(71) Applicant: Ball State Innovation Corporation, Muncie, IN (US)

(72) Inventors: Joshua A. Raines, Muncie, IN (US); Daniel E. Litt, Muncie, IN (US)

(21) Appl. No.: 16/670,572

(22) Filed: Oct. 31, 2019

Related U.S. Application Data
(60) Provisional application No. 62/753,493, filed on Oct. 31, 2018.

(51) Int. Cl. B05B 7/00

(52) U.S. Cl. CPC B05B 7/0081; G06F 3/011

(57) ABSTRACT

An olfactory simulation system is adapted to attach to a virtual reality (VR) or augmented reality (AR) headset to disperse selected scent(s) to the user. The system utilizes a wireless microcontroller to rotate one of a cartridge housing and a base with respect to the other, making one of a plurality of available chambers carried by cartridge housing accessible, while keeping the other chambers carried by the cartridge housing substantially sealed from ambient air. A cartridge carried within the chamber carries a scented material. A fan arranged near the cartridge housing diffuses the selected scent near, but spaced apart from, the user's nose at varying intervals, based on a desired strength.

### CROSS REFERENCE TO RELATED APPLICATION

The present invention claims the benefit of priority to U.S. Provisional Patent Application Ser. No. 62/753,493, titled UNIVERSAL 4D-ATTACHMENTS FOR HEAD-MOUNTED DISPLAYS WITH OLFACTORY SIMULATION, filed Oct. 31, 2018, incorporated herein by reference.

### FIELD

An olfactory simulation system is adapted to attach to a virtual reality (VR) or augmented reality (AR) headset to disperse selected scent(s) to the user. The system utilizes a wireless microcontroller to rotate one of a cartridge housing and a base with respect to the other, making one of a plurality of available chambers carried by cartridge housing accessible, while keeping the other chambers carried by the cartridge housing substantially sealed from ambient air. A cartridge carried within the chamber carries a scented material. A fan arranged near the cartridge housing diffuses the selected scent near, but spaced apart from, the user's nose at varying intervals, based on a desired strength.

### BACKGROUND

Conventional scent delivery augmentation systems include those shown and described in U.S. Pat. Nos. 9,925,458; 9,925,459; 10,065,113; and 9,907,876. Such systems typically place a user's face in a closed/sealed facemask, and use aerosols dispensed through a hole disposed directly in front of the user's nose to deliver the scent. It would be difficult to determine whether the release of an olfactory cue is being processed as it would in natural reality, or if the user is sensitive to the pressure change produced by a release of aerosol gas in close proximity to the sphenoid, thereby possibly causing false innervation.

A significant drawback of the aforementioned prior art methods is that each system leaves undissipated residue within a sealed facemask. As these aerosol-delivered particles settle within the mask, any new activations/scents will always include trace elements of the previously discharged aerosols. Such methods are not suited for a broad range of scents (e.g., unpleasant smells, such as those used in training simulations to help identify [virtual] spaces used in the manufacture of opioids, or checking appliances for the odor of gas leaks). The discharge of pressurized aerosol in a closed system could also falsely activate the olfactory reactions to sudden pressure change, causing false innervation structures in the sphenoid/paranasal system.

### SUMMARY

The disclosed sensory augmentation system is distinguishable over the prior art for many reasons, one of which being that it utilizes disposable scent cartridges instead of discharging aerosol sprays in close proximity to a user's nasal cavity within a sealed environment (i.e., the facemask). The conventional systems discussed above leave undissipated residues behind, making such systems unable to readily accommodate unpleasant smells without thorough cleaning of the apparatus after each use. The universal-fit, open design of the current invention (rather than a closed aerosol system used in the prior art) makes this a more natural form of sensory augmentation, thus serving as a novel improvement in scent dispersion hardware and its ability to immerse users, especially when being used in psychotechnic applications such as training/simulation activities.

In some embodiments, the present invention includes an olfactory simulation system comprising a base including a cutout; a cartridge housing including a plurality of chambers; and a servo operatively coupled to the base and the cartridge, the servo configured to rotate one of the base and the cartridge housing with respect to the other of the base and the cartridge housing to align one of the plurality of chambers with the cutout; wherein each of the plurality of chambers not aligned with the cutout are sealed. In some embodiments, the system further includes a container including a top, bottom, and at least one side extending between the top and the bottom, the container having an interior; and wherein the cartridge housing and the base are located within the interior.

In further embodiments, the base includes at least one stopping element shaped to at least partially insert into the chamber and substantially seal the chamber. In certain embodiments, the base includes a number of stopping elements shaped to substantially seal the plurality of chambers, and wherein the plurality of chambers exceeds the number of stopping elements by one. In some embodiments, the system further includes a shaft extending between the servo and the base.

In further embodiments, the system further includes a microcontroller operatively coupled to the servo. In certain embodiments, the microcontroller is configured to receive a signal from a computing system and activate the servo pursuant to the signal. In some embodiments, the computing system is in wireless communication with the microcontroller. In further embodiments, the system further includes a fan and a microcontroller operatively coupled to the fan. In certain embodiments, the microcontroller is configured to receive a signal from a computing system and activate the fan pursuant to the signal.

In some embodiments, the system further includes a container including a top, bottom, and at least one side extending between the top and the bottom, the container having an interior; and wherein the cartridge housing, the base, the microcontroller, and the fan are located within the interior. In further embodiments, the container includes at least one vent, and wherein the fan configured to guide air from the interior through the at least one vent. In certain embodiments, the container is spaced apart from a user's nose. In some embodiments, the system further includes means for removably attaching the container to a headset. In further embodiments, the system includes a mount configured to removably attach to a headset; and wherein the base is attached to the mount. In certain embodiments, the system includes a gasket positioned between the base and the cartridge housing, the gasket forming a slidable seal between the base and the cartridge housing. In some embodiments, the base includes a raised ridge shaped to receive a portion of the cartridge housing.

In further embodiments, the system includes at least one scent cartridge configured to fit within one of the plurality of chambers. In certain embodiments, the scent cartridge includes a shell, the shell having a scent capsule and infill material therewithin. In some embodiments, the shell is constructed to be deformable by hand, and wherein the scent capsule is constructed to be fracturable by hand. In further embodiments, the scent capsule contains a scented liquid, gas, or solid. In certain embodiments, the scent capsule contains a scented liquid. In some embodiments, the infill material is composed of material to absorb or adsorb the scented liquid. In further embodiments, the scent cartridge includes a cylindrical shell for containing a scented material, the shell having an open end and a vented end opposite end the open end, and a cap for removably sealing the open end.

### BRIEF DESCRIPTION OF THE DRAWINGS

The above-mentioned and other features of this disclosure, and the manner of attaining them, will become more apparent and the disclosure itself will be better understood by reference to the following description of embodiments of the disclosure taken in conjunction with the accompanying drawings, wherein:

FIG. 1A illustrates an exemplary conventional headset to which the invention may be attached.

FIG. 1B illustrates a front plan view of a head-mounted display with a first embodiment of the invention attached thereto.

FIG. 2 illustrates a front view of the interior of the container according to the first embodiment.

FIG. 3 illustrates in isolation the shaft and base of the first embodiment that interacts with the cartridge housing shown in FIG. 2.

FIG. 4 illustrates a forward view in isolation of the stopper element of the shaft shown in FIG. 3.

FIG. 5 illustrates a front plan view of a head-mounted display with a second embodiment of the invention attached thereto.

FIG. 6A illustrates a front plan view of a base according to the second embodiment.

FIG. 6B illustrates a top perspective view of the base of FIG. 6A.

FIG. 7A illustrates a front plan view of a cartridge housing according to the second embodiment.

FIG. 7B illustrates a top perspective view of the cartridge housing of FIG. 7A.

FIG. 7C illustrates a bottom side perspective view of the cartridge housing carried on the base.

FIG. 7D illustrates a front plan view of the cartridge housing carried on the base.

FIG. 7E illustrates the relative positioning of the fan, frame, cartridge housing, and base.

FIG. 8A illustrates a front plan view of a spring gasket according to the second embodiment.

FIG. 8B illustrates a top perspective view of the spring gasket of FIG. 8A.

FIG. 9A illustrates a front plan view of a base gasket according to the second embodiment.

FIG. 9B illustrates a rear plan view of the base gasket of FIG. 9A.

FIG. 10 illustrates a top plan view of a back gasket according to the second embodiment.

FIG. 11 illustrates a first exemplary scent cartridge.

FIG. 12 illustrates a second exemplary scent cartridge.

Corresponding reference characters indicate corresponding parts throughout the several views. Although the drawings represent embodiments of the present disclosure, the drawings are not necessarily to scale and certain features may be exaggerated in order to better illustrate and explain the present disclosure.

### DETAILED DESCRIPTION OF THE EXEMPLARY EMBODIMENTS

The embodiments disclosed below are not intended to be exhaustive or limit the disclosure to the precise forms disclosed in the following detailed description. Rather, the embodiments are chosen and described so that others skilled in the art may utilize their teachings.

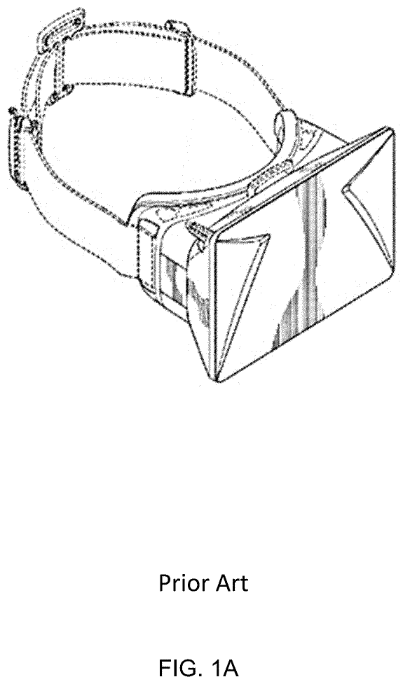

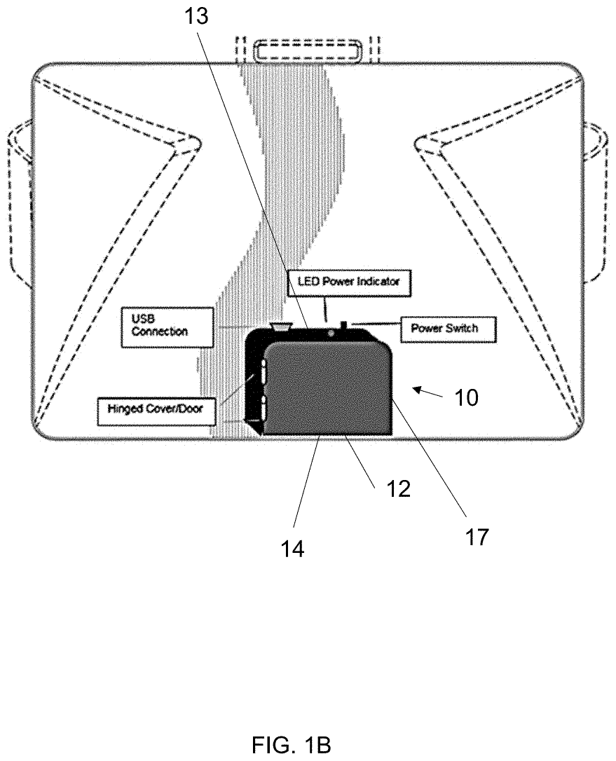

FIG. 1A shows an exemplary virtual reality headset to which the present invention system 10, 410 could be attached. Such a conventional headset is available from Oculus VR, LLC (Menlo Park, Calif.), and is the subject of U.S. Design Pat. No. D738,374.

As shown in FIG. 1B, a first embodiment of an olfactory simulation system 10 includes a container 12 having a top 13, bottom 14, and at least one side 17 extending between the top 13 and bottom 14, such that top 13, bottom 14, and at least one side 17 define an interior 19 of the container 12. The container 12 is preferably secured via conventional means (e.g., adhesive, hook-and-loop style fasteners attached to the system 10 and headset, friction fit, snap fit, etc.) near the bottom edge of the front side of the headset so the scents are dispersed by the invention downwardly toward the user's nose and nasal passages, but the user's nose remains external to the system 10. In some embodiments, such as shown in FIG. 1B, the container 12 includes a LED power indicator, a power switch to activate or deactivate the system 10, a USB connection port or other means for accepting wired connectivity from a computing system, and a hinged cover or door allowing access to the interior 19 of the container 12.

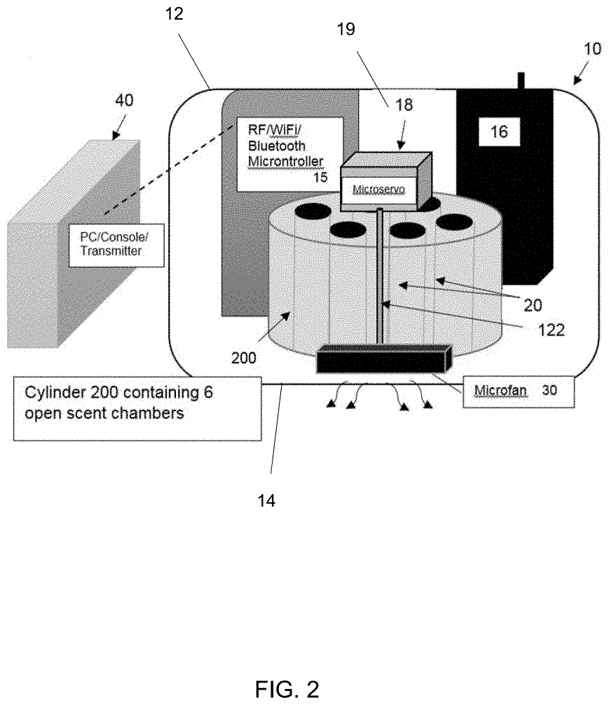

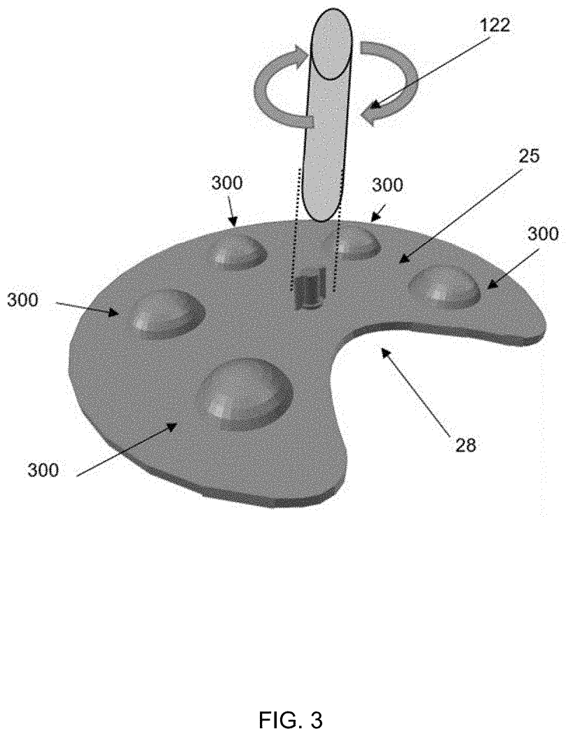

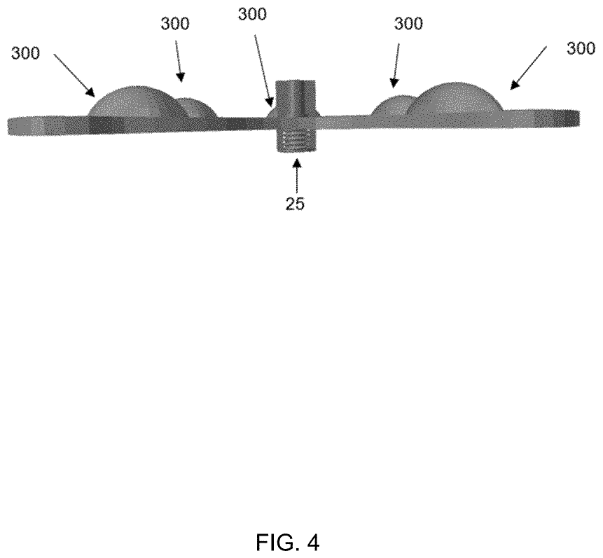

As shown in FIGS. 2-4, an olfactory simulation system 10, which is adapted to attach to the front of a VR or AR headset to disperse selected scent(s) to the user, is described herein. In a current embodiment, the system 10 utilizes a wireless microcontroller 15 to rotate a shaft 122 to one of six (6) available chambers 20 carried by a cylindrical cartridge housing 200, while keeping the other chambers sealed from ambient air. A small fan 30, such as a microfan, arranged at the bottom 14 of the container 12, guides the selected scent out from the interior 19, through the at least one vent (not shown, on bottom of housing 200), near the user's nose at varying intervals, based on a desired strength and controlled by computing system 40, which, in some embodiments, may be a personal computer (PC), console, smartphone, tablet, or similar system in wireless communication with microcontroller 15. System 10 is preferably powered by a power source or battery 16. The fan 30 may be located internal to the container 12 and disperse scent thorough at least one vent (not shown) in the bottom 14 of the housing 200.

The system 10 is activated by a wireless signal that is delivered to microcontroller 15, which activates the fan 30 and instructs servo 18 to move to a desired position. As the servo 18 moves, it rotates a shaft 122 attached to a spring-loaded base 25 arranged adjacent the bottom side of cartridge housing 200. Stopper base 25 includes five (5) upwardly mounded plugs or stopping elements 300 that seal the chamber from the scent above, and includes a shaped cutout 28 allowing one scent to be activated and dispersed at a time. Shaft 122 and base 25 preferably rotate in unison. As shaft 122 rotates, the mounded plugs 300 bias or push the spring-loaded base 25 downwardly until it reaches the desired position. When the servo 18 rotates base 25 to its desired position, the biasing-tension pushes the mounded plugs 300 upwardly into the inactive chambers 20, thereby sealing them from ambient air, while leaving the active chamber accessible.

In some embodiments, software hosted on the computing system 40 controls the transmission of signals to the microcontroller 15 determining the ordering and timing of activation of the servo 18 and fan 30, therefore controlling the ordering and timing of the release of scent from the various chambers 20. One or more of the chambers 20 in the cartridge housing 200 include a scent cartridge 100 for releasing a specific scent.

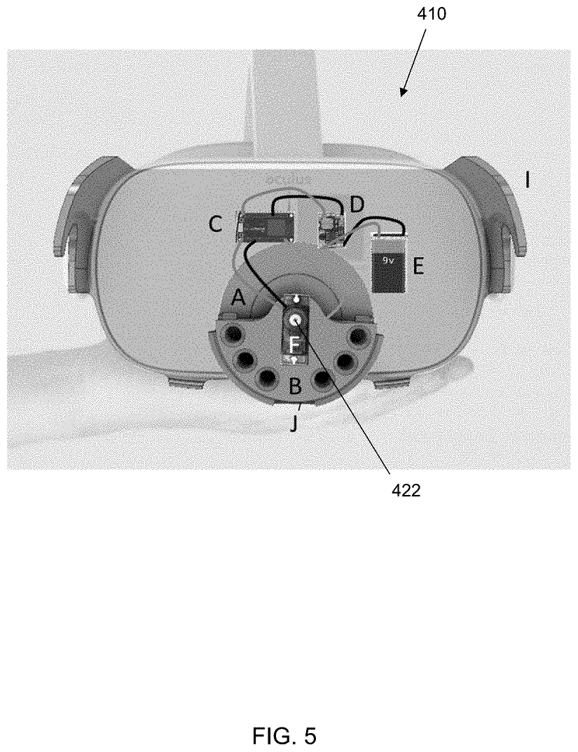

As shown in FIGS. 5 through 10, a second embodiment of an olfactory simulation system includes a base A, a rotatable cartridge housing B, a microcontroller C, an optional stepdown converter D, a power source or battery E, a servo F for rotating the cartridge housing B with respect to base A, a mount I, and a fan J. The mount I is configured to attach to the front side of a VR/AR headset via conventional means (e.g., adhesive, hook-and-loop style fasteners attached to the system 10 and headset, friction fit, snap fit, etc.) so the scents are dispersed by the invention downwardly toward the user's nose and nasal passages, but the user's nose remains external to the system 410. Shaft 422 extends from servo F, through cartridge housing B, and engages base A, such that activation of the servo F results in rotation of the cartridge housing B relative to base A. Similar to the first embodiment, software hosted on a computing system (not shown) controls the transmission of signals to the microcontroller C determining the ordering and timing of activation of the servo F and fan J, therefore controlling the ordering and timing of the release of scent from the various chambers 420.

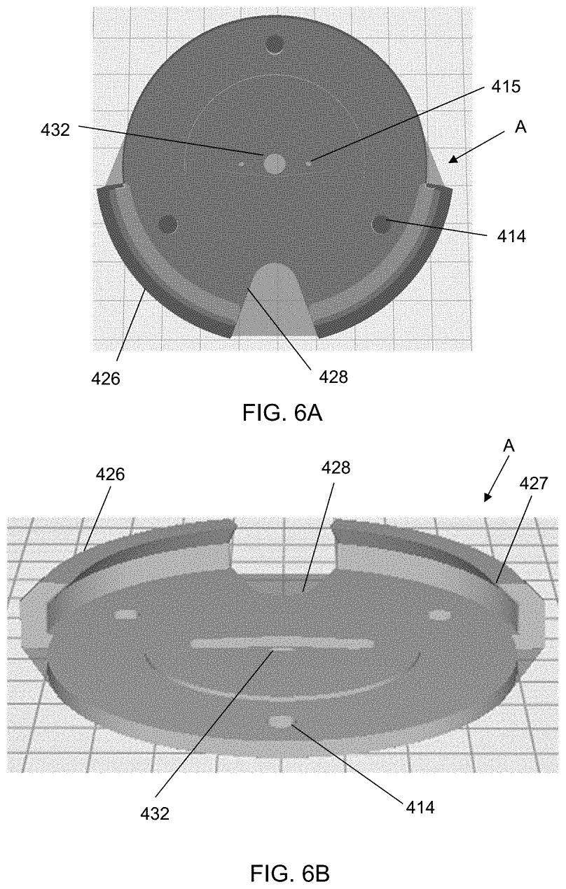

Referring now to FIGS. 6A and 6B, base A is attached to mount I via conventional means, such as fasteners extending through holes 415 into mount I. Base A is generally circular in shape, including a raised ridge 426 having an overhang 427. The raised ridge 426 is sized and shaped to receive a portion of cartridge housing B beneath overhang 427. Base A further includes cutout 428 which creates a gap in the raised ridge 426. Base A further includes a central bore 432 for receiving shaft 422 attached to servo F. Base A further includes one or more indentions 414.

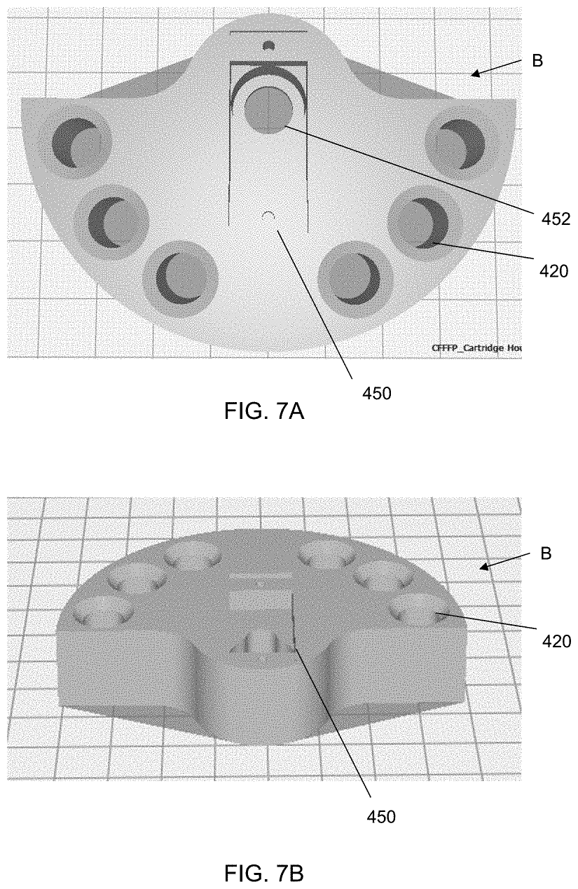

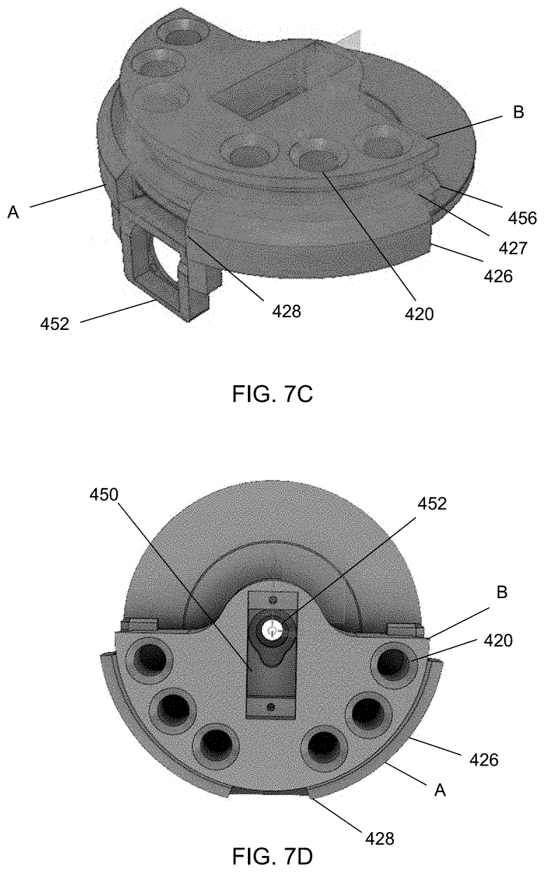

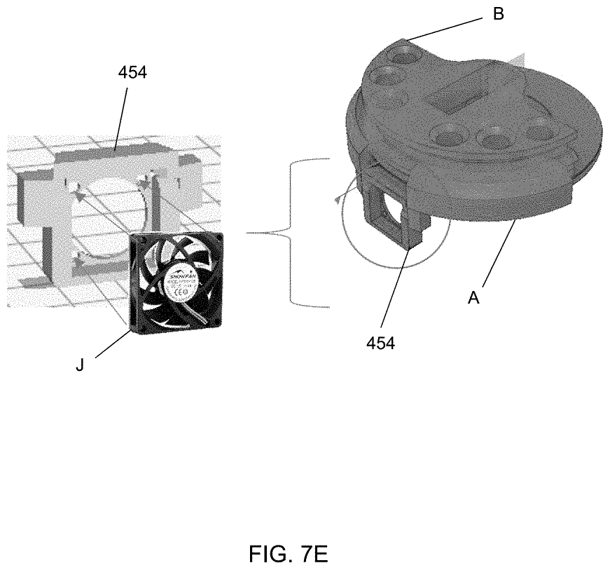

Referring now to FIGS. 7A and 7B, cartridge housing B is generally semicircular in shape, and includes a plurality of chambers 420 spaced around the perimeter of the cartridge housing B. The cartridge housing B further includes a cutout 450 shaped to receive at least a portion of servo F, the cutout 450 including a bore 452 for receiving a shaft (not shown) attached to servo F.

Referring now to FIGS. 7C, 7D, and 7E, the cartridge housing B fits adjacent to the base A and a portion of the perimeter of the cartridge housing B is received by the raised ridge 426. Cartridge housing B and base A fit such that central bore 432 and bore 452 are aligned. A substantially rectangular frame 454 extends perpendicular to the base A and is sized to accept a fan J.

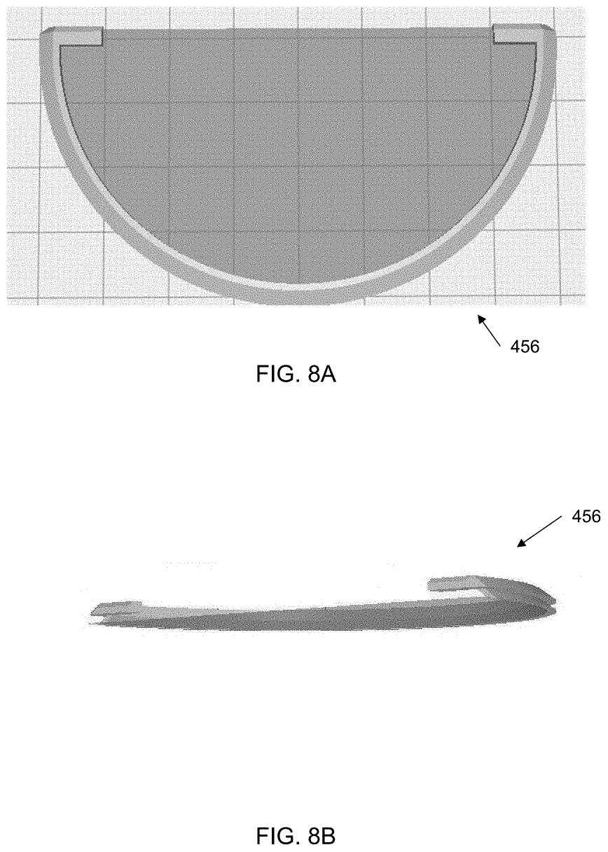

Referring now to FIGS. 8A and 8B, spring gasket 456 is a flexible structure, in some embodiments made of rubber, which attaches to the cartridge housing B, providing tension between the cartridge housing B and the base A. As shown in FIG. 7C, spring gasket fits around a portion of cartridge housing B, fitting between cartridge housing B and the raised ridge 426 to form a slidable, substantially airtight seal between the two, preventing scent from escaping.

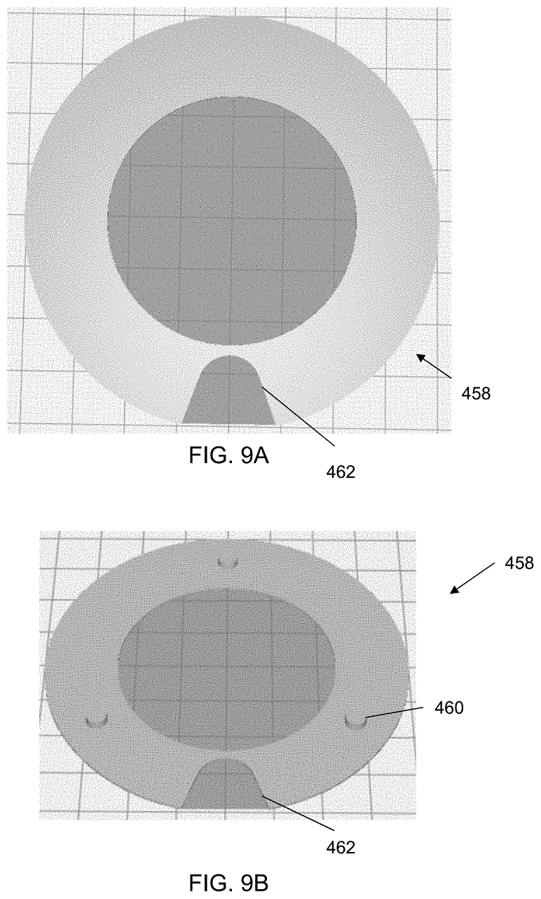

Referring now to FIGS. 9A and 9B, base gasket 458 is a ring-shaped flexible structure, in some embodiments made of rubber, which attaches to the base A. Base gasket may include one or more protrusions 460 which engage the one or more indentions 414 in base A to maintain the position of the base gasket 458 with respect to the base A. The base gasket 458 further includes a cutout 462 that aligns with the cutout 428 of the base A.

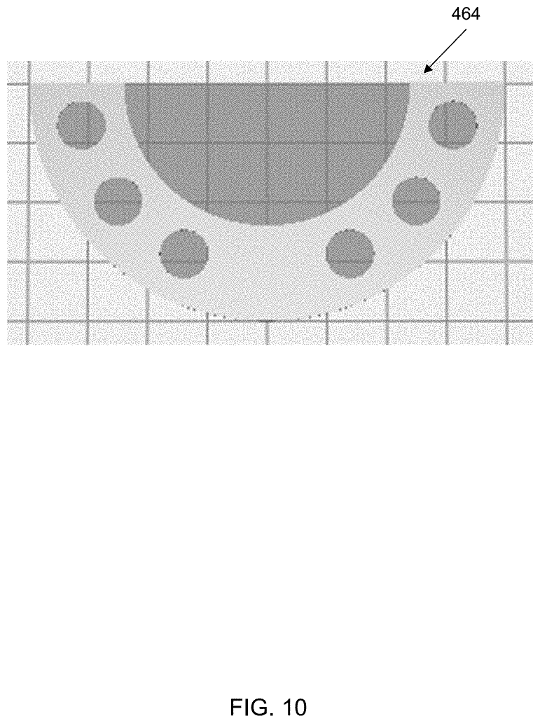

Referring now to FIG. 10, rear cartridge housing gasket 464 is a curved, flexible structure shaped like a segment of a ring, in some embodiments made of rubber. Gasket 464 is attached to the rear of cartridge housing B, and fits between cartridge housing B and base gasket 458, while base gasket 458 fits between gasket 464 and base A. The gaskets 458, 464 contact each other to form a slidable, substantially airtight seal between the two, preventing scent from escaping. However, when cartridge B and gasket 464 are rotated by servo F such that as chamber 420 aligns with cutouts 428, 462, scent from that chamber may escape downwards through the cutout in proximity to fan J for further dispersal.

The described first and second embodiments of olfactory simulation systems 10, 410 both include a cartridge housing 200, B having six chambers 20, 420. However, it should be understood that cartridge housings with different numbers of chambers are within the scope of this invention.

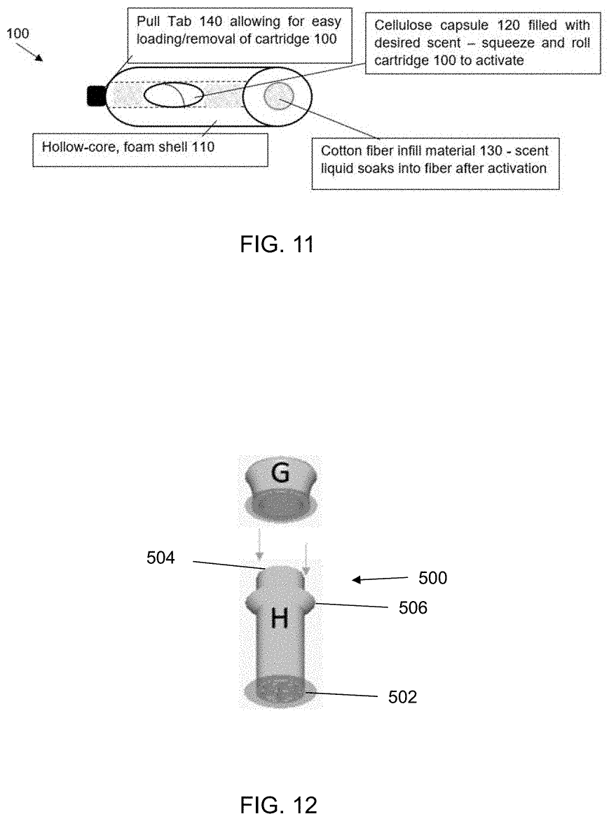

As shown in FIG. 11, a first exemplary scent cartridge 100 preferably includes a shell 110 made of foam or other deformable material and is activated by the user squeezing the shell 110 and activating (by fracturing or breaking open) a custom scent capsule 120 encased within cartridge 100. Typically, a cartridge 100 is activated prior to loading the cartridge into a chamber 20, 420. The scent capsule contains a scented liquid, gas, or solid. In some embodiments, cartridge 100 further includes cotton-fiber infill material 130 that absorbs the liquid scent once it is freed from capsule 120. In other embodiments, the infill material 130 is a wax that absorbs or adsorbs the liquid scent once it is freed from the capsule 120. Capsule 120 can be adjusted to varying strengths by changing the volume or concentration of the liquid scent therein or by other means known in the art. In some embodiments, cartridges 100 include a pull tab 140 on an end of the shell 110 for ease of grasping and removing the cartridge 100 from a chamber 20, 420. The cartridges 100 are loaded into the chambers 20, 420 of cartridge housing 200, B of the invention described herein, via pull tab 140. In the cartridge housing 200 of the first embodiment, one chamber 20 is typically left empty to provide a “no smell” or “no scent” condition.

Referring now to FIG. 12, a second exemplary scent cartridge 500 includes a generally cylindrical shell H and a cap G. Shell H includes a vented bottom 502, an open top 504, and a flange 506. In preparation for use, a scented solid, such as solid at room temperature wax, is inserted into the shell H. Cap G is then fitted onto the top of shell H, abutting flange 506, and sealing the scented solid within the shell H. The vented bottom 402 is removably sealed by an impermeable cover, such as adhesive foil. The cartridge 400 can then be transported or stored without appreciable release of scent. When ready for use, the impermeable cover is removed prior to loading the cartridge 500 into a chamber 20, 420. The vented bottom 502 of the cartridge 500 is inserted into the chamber 20, 420 until the flange 506 contacts the cartridge housing 200, B, forming a seal. The cartridge 500 remains in the chamber 20, 420 via a friction fit.

The cartridges 100, 500 both possess a long shelf life (preferably greater than 24 mos.) before activation. Once activated, the cartridges 100, 500 can remain potent/active for several days or several weeks, depending on the scent and whether a liquid or wax-based scented material is used. The scented materials remain within their respective cartridges 100, 500 and do not come into direct contact with other components of the system 10, 410, thereby significantly reducing the potential for residual contamination as compared to known conventional scent delivery systems.

A suitable application of this technology is as an education appliance and augmentation to systems employing head-mounted displays, although it also has broad commercial appeal in health/healthcare, entertainment, gaming markets, and as a “smart” air refresher device (e.g., Amazon Alexa®-enabled, Google Home®) as well. Conventional scent delivery augmentation systems typically place a user's face in a closed/sealed facemask, and use aerosols dispensed through a hole disposed directly in front of the user's nose to deliver the scent. These systems are unable to effectively accommodate unpleasant or acrid odors, as direct application to a user's nose could be distasteful or even harmful. In addition, aerosols leave residue that may contaminate hardware, particularly if the scent is released into an enclosure and cannot readily diffuse away.

The disclosed system 10, 410 of the current invention employs a fan 30, F to disperse a scent downwards from the front of a headset, so the user's nose is not enclosed with the scent and the scent is not directed onto the headset. This system is, thus, better able to accommodate unpleasant and acrid odors and prevent undesirable residues from contaminating the hardware.

This system 10, 410, is further suitable for training and simulations, therapeutic applications, gaming, static VR experiences, videos/movies/films, and even still images. Other applications include therapeutic applications, such as, for example, simulations that assist combat veterans in better coping with triggers of post-traumatic stress syndrome by combining VR combat experiences with scents of gunpowder. Other applications include training law enforcement personnel to recognize houses where illegal drugs are manufactured by combining VR experiences of exploring a house with the scents of chemicals used to manufacture drugs.

As a wireless [smart] air refresher device, this system can be programmed to emit a variety of scents at a variety of intervals, with a variety of intensities through voice-activated commands. Thus, complex scent profiles can be loaded and smart home devices (such as those listed previously) can activate scents in different sequences, adjust intensities (by preset fan speeds), and be controlled by conventional methods associated with smart home automation systems.

The cartridge-based, open design of the present invention leaves the scent exposure to occur and dissipate in ambient air. The novelty of this system is articulated by its universal-fit design that fits all VR and most AR/XR headsets currently on the market by simply attaching to the front of the headset. Moreover, its alternative scent dispersion method does not depend on discharging pressurized aerosol cartridges into a sealed facemask, in relatively close proximity to user's paranasal system. This limits contaminating scents/residue left by undissipated aerosol, allowing for more accurate representation of scent information. The current invention also limits the likelihood of false innervation within paranasal structures, where users might be reacting more to the sudden discharge of a pressurized gas more than the odor itself. Finally, keeping the scent outside of the closed facemask makes the use of unpleasant odors possible, without fear of contamination/residue being left on the apparatus.

While the novel technology has been illustrated and described in detail in the figures and foregoing description, the same is to be considered as illustrative and not restrictive in character, it being understood that only the preferred embodiments have been shown and described and that all changes and modifications that come within the spirit of the novel technology are desired to be protected. As well, while the novel technology was illustrated using specific examples, theoretical arguments, accounts, and illustrations, these illustrations and the accompanying discussion should by no means be interpreted as limiting the technology. All patents, patent applications, and references to texts, scientific treatises, publications, and the like referenced in this application are incorporated herein by reference in their entirety.

While this disclosure has been described as having an exemplary design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains.

1. An olfactory simulation system comprising:
a base including a cutout;
a cartridge housing including a plurality of chambers; and
a servo operatively coupled to the base and the cartridge, the servo configured to rotate one of the base and the cartridge housing with respect to the other of the base and the cartridge housing to align one of the plurality of chambers with the cutout;
wherein each of the plurality of chambers not aligned with the cutout are sealed.

2. The olfactory simulation system of claim 1, further comprising:
a container including a top, bottom, and at least one side extending between the top and the bottom, the container having an interior; and
wherein the cartridge housing and the base are located within the interior.

3. The olfactory simulation system of claim 2, wherein the base includes at least one stopping element shaped to at least partially insert into the chamber and substantially seal the chamber.

4. The olfactory simulation system of claim 3, wherein the base includes a number of stopping elements shaped to substantially seal the plurality of chambers, and wherein the plurality of chambers exceeds the number of stopping elements by one.

5. The olfactory simulation system of claim 1, further comprising a shaft extending between the servo and the base.

6. The olfactory simulation system of claim 1, further comprising a microcontroller operatively coupled to the servo.

7. The olfactory simulation system of claim 6, wherein the microcontroller is configured to receive a signal from a computing system and activate the servo pursuant to the signal.

8. The olfactory simulation system of claim 7, wherein the computing system is in wireless communication with the microcontroller.

9. The olfactory simulation system of claim 1, further comprising a fan and a microcontroller operatively coupled to the fan.

10. The olfactory simulation system of claim 9, wherein the microcontroller is configured to receive a signal from a computing system and activate the fan pursuant to the signal.

11. The olfactory simulation system of claim 9, further comprising:
a container including a top, bottom, and at least one side extending between the top and the bottom, the container having an interior; and
wherein the cartridge housing, the base, the microcontroller, and the fan are located within the interior.

12. The olfactory simulation system of claim 11, wherein the container includes at least one vent, and wherein the fan is configured to guide air from the interior through the at least one vent.

13. The olfactory simulation system of claim 11, wherein the container is spaced apart from a user's nose.

14. The olfactory simulation system of claim 11, further comprising means for removably attaching the container to a headset.

15. The olfactory simulation system of claim 1, further comprising a mount configured to removably attach to a headset; and
wherein the base is attached to the mount.

16. The olfactory simulation system of claim 1, further comprising a gasket positioned between the base and the cartridge housing, the gasket forming a slidable seal between the base and the cartridge housing.

17. The olfactory simulation system of claim 1, wherein the base includes a raised ridge shaped to receive a portion of the cartridge housing.

18. The olfactory simulation system of claim 1, further comprising at least one scent cartridge configured to fit within one of the plurality of chambers.

19. The olfactory simulation system of claim 18, wherein the scent cartridge includes a shell, the shell having a scent capsule and infill material therewithin.

20. The olfactory simulation system of claim 19, wherein the shell is constructed to be deformable by hand, and wherein the scent capsule is constructed to be fracturable by hand.

21. The olfactory simulation system of claim 19, wherein the scent capsule contains a scented liquid, gas, or solid.

22. The olfactory simulation system of claim 21, wherein the scent capsule contains a scented liquid.

23. The olfactory simulation system of claim 19, wherein the infill material is composed of material to absorb or adsorb the scented liquid.

24. The olfactory simulation system of claim 18, wherein the scent cartridge includes:
a cylindrical shell for containing a scented material, the shell having an open end and a vented end opposite end the open end, and
a cap for removably sealing the open end.
